(19) United States
(12) Patent Application Publication
(10) Pub. No.: US 2013/0232086 A1
(43) Pub. Date: Sep. 5, 2013

(54) SYSTEM AND METHOD FOR MANAGING CONTENT DISTRIBUTION AND BROKERING ROYALTIES

(71) Applicant: ISAAC S. DANIEL, Miramar, FL (US)

(72) Inventor: ISAAC S. DANIEL, Miramar, FL (US)

(21) Appl. No.: 13/080,660

(22) Filed: Apr. 6, 2011

Related U.S. Application Data
(60) Provisional application No. 61/374,893, filed on Aug. 18, 2010.
(60) Provisional application No. 61/444,162, filed on Feb. 18, 2011.
(60) Provisional application No. 61/454,855, filed on Mar. 21, 2011.
(60) Provisional application No. 61/467,243, filed on Mar. 24, 2011.

(51) Int. Cl. G06Q 50/00

(52) U.S. Cl. 705/310

(57) ABSTRACT

A system comprising at least one processor, and computer executable instructions operative to analyze at least one piece of content at a point of consumption, identify at least one distribution right associated with at least one piece of content, determine at least one condition (not shown) at the content's point of consumption, wherein the at least one condition is associated with the at least one distribution right, and broker or apportion royalty fees between at least one first distributor of the at least one piece of content and at least one second distributor of the at least one piece of content based on the at least one distribution right and/or the at least one condition.

### PRIORITY CLAIM

This patent application is a continuation-in-part patent application and claims priority to U.S. Provisional Patent Application Ser. No. 61/374,893, titled “Portable Media System and Method,” filed Aug. 18, 2010; U.S. Provisional Patent Application Ser. No. 61/444,162, titled “Portable Media System and Method,” filed Feb. 18, 2011; U.S. Provisional Patent Application Ser. No. 61/454,855, titled “System and Method for Authenticating a User's Authorization to Receive Streamed Content Using a Wireless HDMI Dongle,” filed Mar. 21, 2011; U.S. Provisional Patent Application Ser. No. 61/467,243, titled “System and Method for Managing and Monitoring Content Distribution and Access,” filed Mar. 24, 2011; all of which are hereby incorporated by reference as if fully stated herein.

### FIELD

The present disclosure relates generally to electronic systems, apparatuses, and methods, and more particularly, to systems, methods, and various other disclosures related to digital content distribution and access.

### BACKGROUND

The prevalence of film industry piracy has grown exponentially over the past several years, and many of the current Digital Rights Management Systems have proven ineffective. Furthermore, as copying of digital content has grown and the distribution of digital content has become more convoluted, tracking of content's distribution has been more difficult to accomplish, and therefore royalty collection or revenue management between content owners and distributors has been more difficult to carry out. In the same light, often times distributors continue to distribute content long after their distribution contracts with content owners have terminated, and there is no way for the content owner to tell if the former distributor is distributing content without permission and without providing renumeration.

Traditionally, there has been various DRM systems devised to help solve these issues, such as Verimatrix's VCAS, and Civolution's Broadcast Monitoring and Automatic Content Recognition systems, however no system exists today that allows content to be tracked from its creation at a post-production house to its consumption at a consumer location, with pinpoint accuracy and real-time reporting that allows for royalty and fee management to be performed between content distributors and content owners.

Furthermore, many media service providers, such as cable and television companies, provide their customers with content. One such means for delivering content includes cable television systems, which include cable set top boxes, and internet TV (IPTV), which is delivered view an IPTV set top box.

Up until now, access to content has been restricted on a geographic basis. Thus, if a customer would like to watch the same programming at home while traveling, they are unable to do so.

### SUMMARY

The various embodiments of systems described herein result from the realization that digital content distribution and monitoring can be made more effective and cost-efficient by providing a system that attached data packets to content at the point of distribution and monitors and analyzes content at the point of consumption via a module or dongle at the point of consumption, collects relevant information at the point of consumption via the module or dongle, and authorizes the content's playback at the point of consumption by using the data packets to analyzing the content's legitimacy. The system and methods described herein further allow for royalties to be apportioned accurately and effectively between distributors and content owners alike.

Accordingly, the various embodiments and disclosures described herein solve the limitations of the prior art in a new and novel manner.

### BRIEF DESCRIPTION OF THE DRAWINGS

FIG. 1 shows a system in accordance with one embodiment;

FIG. 2 shows a module in accordance with another embodiment;

FIG. 3 shows a block diagram depicting a method in accordance with one embodiment; and

FIG. 4 shows a system in accordance with one embodiment.

### DETAILED DESCRIPTION OF PREFERRED EMBODIMENTS

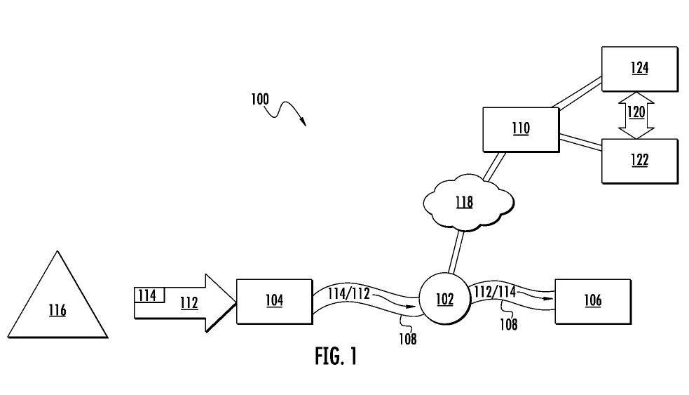

Referring now to FIG. 1, a system 100 is shown, wherein system 100 comprises at least one module 102 including a means to interconnect 108 a content receiving device 104 and a content playing device 106, at least one server 110, and computer executable instructions (not shown) operative to use the module 102 to analyze at least one piece of content 112 being transmitted from the content receiving device 104 to the content playing device 106, identify and at least one distribution right 114 associated with the at least one piece of content 112, determine at least one condition (not shown) of the module 102, content receiving device 104, and/or content playing device 106 associated with the at least one distribution right 114, transmit the at least one distribution right 114 and/or at least one condition to server 110; and broker or apportion royalty fees 120 between at least one first distributor 122 of the at least one piece of content 112, and at least one second distributor 124 of the at least one piece of content 112, based on the at least one distribution right 114 and/or the at least one condition.

In some embodiments, module 102 may comprise a software aspect, such as a computer program, a hardware aspect, such as an integrated hardware module or discrete hardware module, or a combination of hardware and software aspects. In some embodiments, module 102 may be a dongle, including, but not limited to a USB dongle or an HDMI dongle, and may be powered via a USB, HDMI, or external power supply. In some embodiments, dongle 102 comprises at least one processor, at least one storage means, at least one Digital Rights Management (“DRM”) client, and at least one means for communicating with a server, such as, but not limited to, a GSM modem, a Wi-Fi module, a network card, and the like.

In one embodiment, the means for interconnecting 108 a content receiving device 104 and a content playing device 106 may be any means including a wired means, such as HDMI cabling, USB cabling, network cabling and the like, or a wireless means, such as a Bluetooth module, Wi-Fi module, and the like. Content receiving device 104 may comprise any content playing device, such as a cable or satellite TV receiver, and IPTV set top box, a PC, a laptop, and the like. In some embodiments, content playing device 106 may be any content playing device, such as a television, a monitor, a projector, and the like.

In some embodiments, server 110 may be any kind of server, such as a content management server, a computer sever, a content delivery network server, a DRM server, a royalty management server, and the like. Server 110 may be a remote server and may be connected to module 102 via a network 118, such as the internet.

At least one piece of content 112 may be any kind of content, including, but not limited to, digital content, such as movies, music, documents, and the like. In some embodiments, content 112 may be sent to content receiving device 104 from a content provider 116, wherein content provider 116 may be any type of content provider, including, but not limited to, a cable or satellite television provider, a computer readable medium (e.g. DVD, CD, dongle, etc.) vendor, an IPTV provider, and the like. Content 112 may be provided through any means, including, but not limited to, digital delivery or computer readable medium delivery.

In some embodiments, at least one distribution right 114 may be any type of distribution right, or information associated to distribution, such as, but not limited to, a geographic distribution right, such as a territory, a temporal distribution right, such as a release window or a date or time, a venue distribution right, such as a theatre, home, and the like, a medium distribution right, such as television, IPTV, video on demand, DVD, theatrical, and the like, a distributor right, such as a regional distributor, a distribution chain right, such as a list of distributors, an end use distribution right, such as a commercial, residential, business, and the like, content identity, such as the title of the content, distributor identity, such as a name, and a royalty right, such as an amount of royalties to be paid by a viewer, to be apportioned amongst distributors, and the like.

In some embodiments, the at least one condition associated with the at least one distribution right is a physical condition of the module 102, content receiving device 104, or content playing device 106, such as, but not limited to, a geographic location, a temporal condition, such as a date or time, and the like. In other embodiments, the condition could be a commercial condition, such as a type of venue, identity of end user, identity of distributor, medium for distribution, type of end user, and royalty amount. The at least one condition may be ascertained from an IP address, Global Positioning System (“GPS) location information, Wi-Fi positioning system information, GSM positioning system information, manually entered positioning information, and the like, of module 102, content receiving device 104, or content playing device 106. Accordingly, system 100 may further comprise a GPS module, a GSM modem, an internet connection device, and the like.

In some embodiments, distribution right 114 may be contained in at least one data packet that may be any kind of data packet, such as a unique identifier, a DRM tag, a digital fingerprint, or a watermark, such as, but not limited to, an audio watermark and a video watermark. At least one data packet may be integrated with or embedded in content 112, at any point or points in content 112, or may be appended at the front-end or tail-end of content 112. The data packet may contain any information related to content 112, such as where content 112 originated from, where content 112 has resided, distribution rights associated with content 112, chain of title, chain of distribution, copy count information, pricing, subscriber information, such as demographics, and the like.

In some embodiments, first distributor 122 may be any kind of distributor, such as, but not limited to, a primary distributor, which may include a content owner, movie studio, and the like. In a further embodiment, at least one second distributor 124 may be any kind of distributor, including, but not limited to, a secondary distributor, a sub-distributor, a content provider, such as content provider 116, a retail outlet, a website, and the like.

In some embodiments, brokering or apportioning royalty fees 120 may comprise directly brokering or apportioning fees between first distributor 122 and second distributor 124, which may include acting as a royalty management and apportioning service. In an alternate embodiment, brokering or apportioning royalty fees 120 may comprise indirectly brokering or apportioning fees such as by providing information, such as distribution right 114 and the at least one condition relating to distribution right 114 to first distributor 122, second distributor 124, or an independent royalty management/apportionment service provider. In some embodiments, royalty 120 may be a royalty collected from an end user, while in other embodiments, royalty 120 may be a royalty paid between first distributor 122 and second distributor 124.

In some embodiments, the computer executable instructions may be operative to allow or refuse transmission of at least one piece of content 112 from the content receiving device 112 to the content playing device 106 based on at least one of the at least one distribution right 114 and/or the at least one condition relating to the at least one distribution right 114.

In yet a further embodiment, the computer executable instructions may be operative to collect a fee (or royalty) based on the at least one distribution right 114 and/or the at least one condition. The fee may be collected form an end user, or from a distributor. In some embodiment, collecting a fee from an end user may be a prerequisite to allowing content 112 to be played.

In some embodiments, module 102 is operative to communicate with server 110 to determine whether content 112 may be played on content playing device 106. This may involve communicating information contained in distribution right 114 to server 110, and then analyzing the information and comparing to information stored on a database to determine whether content 112 is pirated, whether it has been distributed properly and legally, and whether a user has rights to view content 112. In some embodiments, where the playing of content 112 is unauthorized, module 102 may prevent the content 112 from playing on content playing device 106. Alternatively, where the playing of content 112 is authorized, module 102 may allow content 112 to be played on content playing device 106.

In some embodiments, content 112 shall not play on content playing device 106 without the presence of module 102, or without a functioning module 102, or if a connection between module 102 and server 110 is not established. Accordingly, content playing device 106 or content receiving device 104 may contain a module, either software or hardware, that may detect the presence of module 102 or module's 102 connection to server 110, and refuse or allow the playing of content 112 depending on whether module 102 or module's 102 connection to server 110 is detected.

In a further embodiment, system 100 may prevent content 112 should no data packet 114 be found or should the wrong data packet be found.

In addition to authenticating content 112's playback, module 102 may be used to communicate relevant information to server 110, which may be used to compile statistical information for advertising purposes, content playback royalty collection purposes, pirated content tracking purposes, user experience customization services, and the like. Such information may include subscriber information, such as subscriber demographics, time of playing, geographic location, and the like.

In some embodiments, module 102 may contain a unique subscriber identification module, wherein said module may be a software module or a hardware module, which may be used in the playback authentication process.

In a further embodiment, content 112 may be encoded or encrypted at a point of distribution (e.g. DVD distribution, network distribution, Cable/TV distribution, etc.). Module 102 may be operative to decode or decrypt content 112 at a point of consumption (e.g. consumer's homes, theatres, offices, etc.). In some embodiments, only the module 102 may be authorized to decrypt or decode the content so that it is necessary to have a module to play content 112. In some embodiments, module 102 may decrypt or decode content 112 after having received authorization from server 110.

In some embodiments module 102 may be integrated or embedded in content receiving device 104 and/or content playing device 106.

In some embodiments, module 102 may be operative to interconnect with legacy content receiving devices and content playing devices, which would allow for a more universal application and ease of deployment.

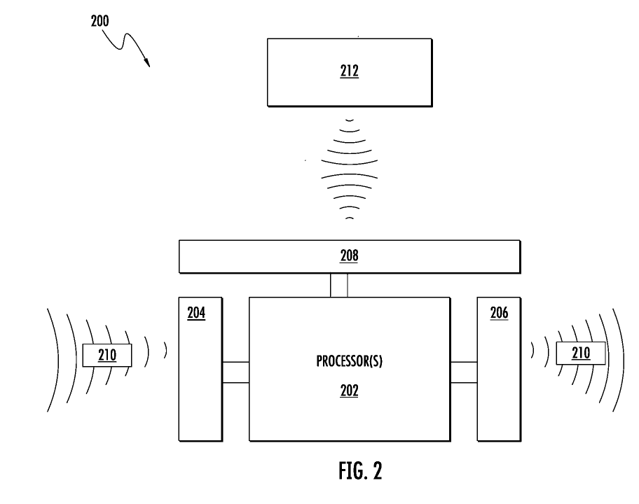

In a further embodiment, module 102 may comprise module 200, described below with reference to FIG. 2.

Referring now to FIG. 2, a content authentication module is shown, comprising at least one processor 202, at least one means 204 for receiving content 210 electronically connected to at least one processor 202, at least one means 206 for playing content 210 electronically connected to at least one processor 202, at least one means 208 with communicating with a server 212, and computer executable instructions readable by at least one processor 202 and operative to analyze at least one piece of content 210 being received by the means 204 for receiving content 210, determining at least one distribution right (not shown) associated with content 210, determining at least one condition of module 200, processor 202, means 204 for receiving content 210, and/or means 206 for playing content 210, communicate the at least one distribution right and/or the at least one condition to server 212, allow or refuse transmission of content 210 based on whether authorization is received from server 210.

The term “electronically connected” as used herein shall include both wired and wireless connections and communications between two pieces of electronics.

At least one processor 202 may be any kind of processor, including but not limited to a single core processor, a multi-core processor, a video processor, and audio processor, a DRM processor, and the like.

In some embodiments, server 212 may use distribution rights data and condition data to broker or apportion royalty fees between at least one first distributor of content 210 and at least one second distributor of content 210 based on the distribution right and/or condition associated with the distribution right.

In some embodiments, module 200 may be incorporated into a larger system, such as system 100 described above with reference to FIG. 1. Accordingly, some or all of the components of module 200 may include or may be operative to work with any or all of the elements of system 100.

In another embodiment, module 200 may comprise a dongle, which may be connected to a means for receiving content, such as a set top box, and/or a means for playing content, such as a television, and the like. Accordingly, means for receiving and/or playing content, 204, 206 content may be a cable, port wireless connection, a content processing chip, and the like.

In another embodiment, module 200 may be integrated with or incorporated into a set top box, such as an IPTV set top box. Accordingly, means for receiving and playing content 204 and 206 may be a content decoder/transceiver, and/or a content rendering chip, port, or cable.

In another embodiment, module 200 may further comprise a dongle connected to at least one processor 202, wherein the dongle may contain a unique identifier to identify the end user, and any distribution rights associated with the end user.

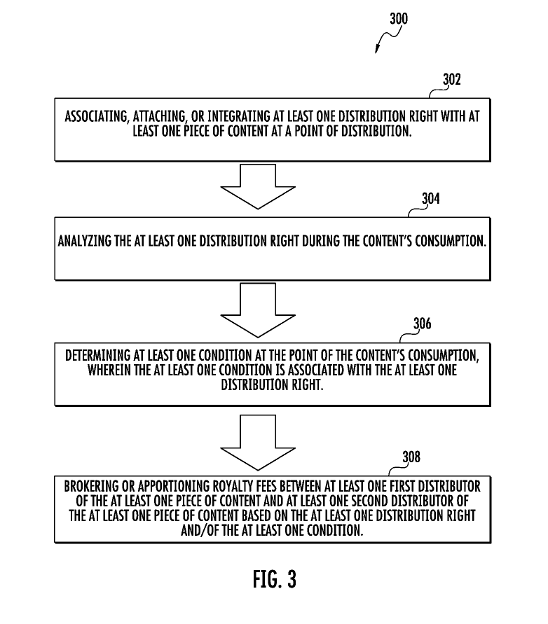

Referring now to FIG. 3, an embodiment of a method 300 is shown for monitoring and managing the distribution of content comprising using at least one processor to perform any or all of the following: associating, attaching, or integrating at least one distribution right with at least one piece of content at a point of distribution (block 302), analyzing the at least one distribution right at (or during) the content's consumption (block 304); determining at least one condition at the point of the content's consumption, wherein the at least one condition is associated with the at least one distribution right (block 306), and brokering or apportioning royalty fees between at least one first distributor of the at least one piece of content and at least one second distributor of the at least one piece of content based on the at least one distribution right and/or the at least one condition (block 308).

In some embodiments, method 300 further comprises allowing or preventing the at least one piece of content's playback at the point of consumption based on the at least one distribution right and/or at least one condition, and/or whether the at least one piece of content has reached the point of consumption through authorized means.

In some embodiments, the point of distribution may be a post-production house, a movie studio, a content delivery network, a DVD factory, a television service provider, and the like. In another embodiment, the point of consumption may be a home, an office, a business, a hotel, an airplane, a mobile device, and the like.

The at least one piece of content may be any kind of content, including, but not limited to, digital content, such as movies, music, documents, and the like. In some embodiments, the content may be sent to a content receiving device from a content provider, wherein content provider may be any type of content provider, including, but not limited to, a cable or satellite television provider, a computer readable medium (e.g. DVD, CD, dongle, etc.) vendor, an IPTV provider, and the like. The content may be provided through any means, including, but not limited to, digital delivery or computer readable medium delivery.

In some embodiments, the at least one distribution right may be any type of distribution right, or information associated to distribution, such as, but not limited to, a geographic distribution right, such as a territory, a temporal distribution right, such as a release window or a date or time, a venue distribution right, such as a theatre, home, and the like, a medium distribution right, such as television, IPTV, video on demand, DVD, theatrical, and the like, a distributor right, such as a regional distributor, a distribution chain right, such as a list of distributors, an end use distribution right, such as a commercial, residential, business, and the like, content identity, such as the title of the content, distributor identity, such as a name, and a royalty right, such as an amount of royalties to be paid by a viewer, to be apportioned amongst distributors, and the like.

In some embodiments, the at least one condition associated with the at least one distribution right is a physical condition such as, but not limited to, a geographic location, a temporal condition, such as a date or time, and the like. In other embodiments, the condition could be a commercial condition, such as a type of venue, identity of end user, identity of distributor, medium for distribution, type of end user, and royalty amount. The at least one condition may be ascertained from an IP address, Global Positioning System (“GPS) location information, Wi-Fi positioning system information, GSM positioning system information, manually entered positioning information, and the like.

In some embodiments, the distribution right may be contained in at least one data packet that may be any kind of data packet, such as a unique identifier, a DRM tag, a digital fingerprint, or a watermark, such as, but not limited to, an audio watermark and a video watermark. At least one data packet may be integrated with or embedded in the content, at any point or points in the content, or may be appended at the front-end or tail-end of the content. The data packet may contain any information related to the content, such as where the content originated from, where the content has resided, distribution rights associated with the content, chain of title, chain of distribution, copy count information, pricing, subscriber information, such as demographics, and the like.

In some embodiments, the first distributor may be any kind of distributor, such as, but not limited to, a primary distributor, which may include a content owner, movie studio, and the like. In a further embodiment, the at least one second distributor may be any kind of distributor, including, but not limited to, a secondary distributor, a sub-distributor, a content provider, such as a content provider, a retail outlet, a website, and the like.

In some embodiments, brokering or apportioning royalty fees may comprise directly brokering or apportioning fees between the first distributor and the second distributor, which may include acting as a royalty management and apportioning service. In an alternate embodiment, brokering or apportioning the royalty fees may comprise indirectly brokering or apportioning fees such as by providing information, such as the distribution right and the at least one condition relating to the distribution right to the first distributor, the second distributor, or an independent royalty management/apportionment service provider. In some embodiments, the royalty may be a royalty collected from an end user, while in other embodiments, the royalty may be a royalty paid between the first distributor and the second distributor.

In some embodiments, method 300 may comprise allowing or refusing transmission of the at least one piece of content from the content receiving device to the content playing device based on at least one of the at least one distribution right and/or the at least one condition relating to the at least one distribution right.

In yet a further embodiment, method 300 may comprise collecting a fee (or royalty) based on the at least one distribution right and/or the at least one condition. The fee may be collected form an end user, or from a distributor. In some embodiment, collecting a fee from an end user may be a prerequisite to allowing the content to be played.

In some embodiments, method 300 may comprise communicating with a server to determine whether the content may be played on a content playing device. This may involve communicating information contained in the distribution right to the server, and then analyzing the information and comparing to information stored on a database to determine whether the content is pirated, whether it has been distributed properly and legally, and whether a user has rights to view the content. In some embodiments, where the playing of the content is unauthorized, the method 300 may comprise preventing the content from playing. Alternatively, where the playing of the content is authorized, method 300 may comprise allowing the content to be played.

In some embodiments, method 300 may comprise not allowing the content to play on a content playing device without the presence of module or dongle, such as modules 102, 200, or without a functioning module, or if a connection between a module and a server is not established.

In a further embodiment, method 300 may comprise preventing playback if no data packet, distribution right, or condition is found or should the wrong data packet, distribution right, or condition be found.

In addition to authenticating the content's playback, method 300 may further comprise communicating relevant information to a server, which may be used to compile statistical information for advertising purposes, content playback royalty collection purposes, pirated content tracking purposes, user experience customization services, and the like. Such information may include subscriber information, such as subscriber demographics, time of playing, geographic location, and the like.

In a further embodiment, method 300 may comprise encoding or encrypting the content at a point of distribution (e.g. DVD distribution, network distribution, Cable/TV distribution, etc.). Method 300 may further comprise decoding or decrypting content at a point of consumption (e.g. consumer's homes, theatres, offices, etc.). In some embodiments, method 300 may comprise requiring a specific dongle to be present in order for any decoding or decryption to take place at the point of the content's consumption. In some embodiments, method 300 may comprise decrypting or decoding content after having received authorization from a server.

In some embodiments the at least one processor may be integrated or embedded in a content receiving device and/or content playing device. In another embodiment, the at least one processor may be part of a server.

In some embodiments, the at least one processor may be operative to interconnect with legacy content receiving devices and content playing devices, which would allow for a more universal application and ease of deployment.

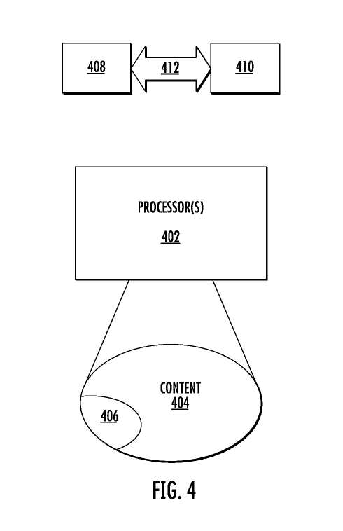

In a further embodiment, the at least one processor may comprise module 102, 200, described below with reference to FIGS. 1 and 2, or processor 402, as described below with reference to FIG. 4.

In some embodiments, method 300 may be carried out in whole or in part by systems 100, 400 or module 200, or the method may call for using, in whole, or in part, systems 100, 400 or module 200 in carrying out its steps.

Referring now to FIG. 4, a system 400 is shown in accordance with one embodiment, wherein system 400 comprises at least one processor 402, and computer executable instructions operative to analyze at least one piece of content 404 at a point of consumption, identify at least one distribution right 406 associated with at least one piece of content 404, determine at least one condition (not shown) at the content's point of consumption, wherein the at least one condition is associated with the at least one distribution right, and broker or apportion royalty fees 412 between at least one first distributor 408 of the at least one piece of content 404 and at least one second distributor 410 of the at least one piece of content based on the at least one distribution right 406 and/or the at least one condition.

In some embodiments, at least one processor 402 may be any kind of processor, including but not limited to a single core processor, a multi-core processor, and the like. In some embodiments, at least one processor 402 may reside in a user PC, mobile device, set top box, or display device, in a dongle connected to a user set top box, PC, mobile device, or display device, in a server, such as a content delivery network server, a royalty management system server, a content provider server, and the like. In some embodiments system 400 comprises a plurality of at least one processor positioned in any single aforementioned device or location, or combination thereof.

The point of consumption may be a home, an office, a business, a hotel, an airplane, a mobile device, and the like. In some embodiments, the distribution rights 406 (and associated information) may be inserted, integrated, attached, embedded, or otherwise associated with content 404 at a point of distribution. In some embodiments, the point of distribution may be a post-production house, a movie studio, a content delivery network, a DVD factory, a television service provider, and the like.

The at least one piece of content 404 may be any kind of content, including, but not limited to, digital content, such as movies, music, documents, and the like. In some embodiments, the content 404 may be sent to a content receiving device from a content provider, wherein content provider may be any type of content provider, including, but not limited to, a cable or satellite television provider, a computer readable medium (e.g. DVD, CD, dongle, etc.) vendor, an IPTV provider, and the like. The content 404 may be provided through any means, including, but not limited to, digital delivery or computer readable medium delivery.

In some embodiments, the at least one distribution right 406 may be any type of distribution right, or information associated to distribution, such as, but not limited to, a geographic distribution right, such as a territory, a temporal distribution right, such as a release window or a date or time, a venue distribution right, such as a theatre, home, and the like, a medium distribution right, such as television, IPTV, video on demand, DVD, theatrical, and the like, a distributor right, such as a regional distributor, a distribution chain right, such as a list of distributors, an end use distribution right, such as a commercial, residential, business, and the like, content identity, such as the title of the content, distributor identity, such as a name, and a royalty right, such as an amount of royalties to be paid by a viewer, to be apportioned amongst distributors, and the like.

In some embodiments, the at least one condition associated with the at least one distribution right 406 may be a physical condition such as, but not limited to, a geographic location, a temporal condition, such as a date or time, and the like. In other embodiments, the condition could be a commercial condition, such as a type of venue, identity of end user, identity of distributor, medium for distribution, type of end user, and royalty amount. The at least one condition may be ascertained from an IP address, Global Positioning System (“GPS) location information, Wi-Fi positioning system information, GSM positioning system information, manually entered positioning information, and the like.

In some embodiments, the distribution right 406 may be contained in at least one data packet that may be any kind of data packet, such as a unique identifier, a DRM tag, a digital fingerprint, or a watermark, such as, but not limited to, an audio watermark and a video watermark. At least one data packet may be integrated with or embedded in the content 404, at any point or points in the content, or may be appended at the front-end or tail-end of the content 404. The data packet may contain any information related to the content 404, such as where the content 404 originated from, where the content 404 has resided, distribution rights associated with the content 404, chain of title, chain of distribution, copy count information, pricing, subscriber information, such as demographics, and the like.

In some embodiments, the at least one first distributor 408 may be any kind of distributor, such as, but not limited to, a primary distributor, which may include a content owner, movie studio, and the like. In a further embodiment, the at least one second 410 distributor may be any kind of distributor, including, but not limited to, a secondary distributor, a sub-distributor, a content provider, such as a content provider, a retail outlet, a website, and the like.

In some embodiments, brokering or apportioning royalty fees 412 may comprise directly brokering or apportioning fees 412 between the first distributor 408 and the second distributor 410, which may include acting as a royalty management and apportioning service. In an alternate embodiment, brokering or apportioning the royalty fees may comprise indirectly brokering or apportioning fees such as by providing information, such as the distribution right 406 and the at least one condition relating to the distribution right 406 to the first distributor 408, the second distributor 410, or an independent royalty management/apportionment service provider. In some embodiments, the royalty 412 may be a royalty collected from an end user, while in other embodiments, the royalty 412 may be a royalty paid between the first distributor 408 and the second distributor 410.

In some embodiments, the computer executable instructions may be operative to allow or refuse transmission of the at least one piece of content 404 based on at least one of the at least one distribution right 406 and/or the at least one condition relating to the at least one distribution right 406.

In yet a further embodiment, the computer executable instructions may be operative to collect a fee (or royalty) based on the at least one distribution right 406 and/or the at least one condition. The fee may be collected form an end user, or from a distributor. In some embodiments, collecting a fee from an end user may be a prerequisite to allowing the content 404 to be played.

In some embodiments, the computer executable instructions may be operative to communicate with a server to determine whether the content 404 may be played. This may involve communicating information contained in the distribution right to the server, and then analyzing the information and comparing to information stored on a database to determine whether the content 404 is pirated, whether it has been distributed properly and legally, and whether a user has rights to view the content 404. In some embodiments, where the playing of the content 404 is unauthorized, the computer executable instructions may be operative to prevent the content 404 from playing. Alternatively, where the playing of the content 404 is authorized, the computer executable instructions may be operative to allow the content 404 to be played.

In some embodiments, the computer executable instructions may be operative to not allow the content 404 to play on a content playing device without the presence of module or dongle, such as modules 102, 200, or without a functioning module, or if a connection between a module and a server is not established.

In a further embodiment, the computer executable instructions may be operative to prevent playback if no data packet, distribution right 406, or condition is found or should the wrong data packet, distribution right 406, or condition be found.

In addition to authenticating the content 404's playback, the computer executable instructions may be operative to communicate relevant information to a server, which may be used to compile statistical information for advertising purposes, content playback royalty collection purposes, pirated content tracking purposes, user experience customization services, and the like. Such information may include subscriber information, such as subscriber demographics, time of playing, geographic location, and the like.

In a further embodiment, the computer executable instructions may be operative to encrypt or encode content 404 at a point of distribution (e.g. DVD distribution, network distribution, Cable/TV distribution, etc.). The computer executable instructions may be further operative to decrypt or decode content 404 at a point of consumption (e.g. consumer's homes, theatres, offices, etc.). In some embodiments, the computer executable instructions may be operative to require a specific dongle to be present in order for any decoding or decryption to take place at the point of the content 404's consumption. In some embodiments, the computer executable instructions may be operative to decrypt or decode content 404 after having received authorization from a server.

In some embodiments the at least one processor 402 may be integrated or embedded in a content receiving device and/or content playing device. In another embodiment, the at least one processor 402 may be part of a server, as mentioned above.

It should be noted that system 400, and any or all of its various components, elements, and processes, may be used in conjunction with or as a part of system 100, module 200, and/or method 300, or any or all of their various components, elements, and processes described above and elsewhere throughout the present disclosure.

In some embodiments, system 400 further comprises at least one server to broker or apportion the royalty fees 412 between at least one first distributor 408 and of the at least one piece of content 404, and at least one second distributor 410 of the at least one piece of content 404.

With reference to systems 100, 400, module 200, and method 300, and the various embodiments thereof, by being able to determine a distribution right at a content's point of consumption, such as a geographic distribution right, as well as a condition at the point of consumption, royalty fees may be calculated based on said distribution rights and conditions, which enables creative royalty calculations for content consumption based on models such as roaming in terms of geographic scope, varying mediums of delivery and viewing, time scope, end use, and the like.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Accordingly, while the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed is:

1. A system for managing content distribution and brokering royalties comprising:
a. at least one module including a means to interconnect a content receiving device and a content playing device;
b. at least one server; and
c. computer executable instructions operative to:
i. use the module to analyze at least one piece of content being transmitted from the content receiving device to the content playing device;
ii. identify at least one distribution right associated with the at least one piece of content;
iii. determine at least one condition of the module, content receiving device, and/or content playing device associated with the at least one distribution right;
iv. transmit the at least one distribution right and/or at least one condition to the server; and
v. broker or apportion royalty fees between at least one first distributor of the at least one piece of content and at least one second distributor of the at least one piece of content based on the at least one distribution right and/or the at least one condition.

2. The system of claim 1 wherein, wherein the computer executable instructions are further operative to allow or refuse transmission of the at least one piece of content from the content receiving device to the content playing device based on at least one of the at least one distribution right and/or the at least one condition.

3. The system of claim 1, wherein the computer executable instructions are further operative to collect a fee based on the at least one distribution right and/or at least one condition.

4. The system of claim 1, wherein the at least one distribution right is a type of distribution right selected from the group consisting of: a geographic distribution right, a temporal distribution right, a venue distribution right, a medium distribution right, a distributor right, a distribution chain right, an end use distribution right, content identity, distributor identity, and a royalty right.

5. The system of claim 1, wherein the at least one condition is a type of condition selected from the group consisting of: a geographic location, a time and/or date, a venue, a medium, a type of end user, and a royalty amount.

6. A content authentication module comprising:
a. at least one processor;
b. at least one means for receiving content electronically connected to the at least one processor;
c. at least one means for playing content electronically connected to the at least one processor;
d. at least one means with communicating with a server electronically connected to the at least one processor; and
e. computer executable instructions readable by the at least one processor and operative to:
i. analyze at least one piece of content being received by the means for receiving content;
ii. determine at least one distribution right associated with the at least one piece of content;
iii. determine at least one condition of the module, processor, means for receiving content, and/or means for playing content associated with the at least one distribution right;
iv. communicate the at least one distribution right and/or the at least one condition to the server;
v. seek authorization from the server to allow the at least one content to play on the means for playing content; and
vi. allow or refuse transmission of the at least one piece of content based on whether authorization is received from the server.

7. The module of claim 6, wherein the computer executable instructions are further operative to collect a fee based on the at least one distribution right and/or at least one condition.

8. The module of claim 6, wherein the at least one distribution right is a type of distribution right selected from the group consisting of: a geographic distribution right, a temporal distribution right, a venue distribution right, a medium distribution right, a distributor right, a distribution chain right, an end use distribution right, content identity, distributor identity, and a royalty right.

9. The module of claim 6, wherein the at least one condition is a type of condition selected from the group consisting of: a geographic location, a time and/or date, a venue, a medium, a type of end user, and a royalty amount.

10. A method for monitoring and managing the distribution of content comprising using at least one processor to perform any or all of the following:
a. associating, attaching, or integrating at least one distribution right with at least one piece of content at a point of distribution;
b. analyzing the at least one distribution right at the content's consumption;
c. determining at least one condition at the point of the content's consumption, wherein the at least one condition is associated with the at least one distribution right; and
d. brokering or apportioning royalty fees between at least one first distributor of the at least one piece of content and at least one second distributor of the at least one piece of content based on the at least one distribution right and/or the at least one condition.

11. The method of claim 10, further comprising allowing or preventing the at least one piece of content's playback based on the at least one distribution right and/or at least one condition.

12. The method of claim 10, further comprising collecting a fee from a viewer based on the at least one distribution right and/or at least one condition.

13. The method of claim 10, wherein the at least one distribution right is a type of distribution right selected from the group consisting of: a geographic distribution right, a temporal distribution right, a venue distribution right, a medium distribution right, a distributor right, a distribution chain right, an end use distribution right, content identity, distributor identity, and a royalty right.

14. The method of claim 10, wherein the at least one condition is a type of condition selected from the group consisting of: a geographic location, a time and/or date, a venue, a medium, a type of end user, and a royalty amount.

15. A system for managing content distribution and brokering royalties comprising:
a. at least one processor; and
b. computer executable instructions readable by the at least one processor and operative to:
i. to analyze at least one piece of content at a point of consumption;
ii. identify at least one distribution right associated with the at least one piece of content;
iii. determine at least one condition at the point of the content's point of consumption, wherein the at least one condition is associated with the at least one distribution right; and
iv. broker or apportion royalty fees between at least one first distributor of the at least one piece of content and at least one second distributor of the at least one piece of content based on the at least one distribution right and/or the at least one condition.

16. The system of claim 15, wherein the computer executable instructions are further operative to allow or refuse transmission of the at least one piece of content based on the at least one distribution right and/or the at least one condition.

17. The system of claim 15, wherein the at least one distribution right is a type of distribution right selected from the group consisting of: a geographic distribution right, a temporal distribution right, a venue distribution right, a medium distribution right, a distributor right, a distribution chain right, an end use distribution right, content identity, distributor identity, and a royalty right.

18. The system of claim 15, wherein the at least one condition is a type of condition selected from the group consisting of: a geographic location, a time and/or date, a venue, a medium, a type of end user, and a royalty amount.

19. The system of claim 15, further comprising at least one server to broker or apportion the royalty fees between at least one first distributor of the at least one piece of content and at least one second distributor of the at least one piece of content.

20. The system of claim 15, wherein the computer executable instructions are further operative to collect a fee based on at least one of the at least one distribution right and/or the at least one condition.
